(19) United States
(12) Patent Application Publication
(10) Pub. No.: US 2023/0064462 A1
(43) Pub. Date: Mar. 2, 2023

(54) COGNITIVE CORE NETWORK SELECTION FOR CONFERENCE CALLING

(71) Applicant: International Business Machines Corporation, Armonk, NY (US)

(72) Inventors: Sathya Santhar, Ramapuram (IN); Samuel Mathew Jawaharlal, Chennai (IN); Sarbajit K. Rakshit, Kolkata (IN); Suvedhahari Velusamy, COIMBATORE (IN)

(21) Appl. No.: 17/410,621

(22) Filed: Aug. 24, 2021

(51) Int. Cl. H04M 3/56

(52) U.S. Cl. CPC H04M 3/56

(57) ABSTRACT

Systems, methods, and computer programming products leveraging cognitive computing and machine learning to dynamically establish circuits within conference calls merging in new callers. The newly established circuits are optimized and established based on location attributes of the new caller and conference call participants, as well as the calling plans and/or costs associated with establishing the circuits to the different conference call participants. New circuits merging in new callers can be prioritized to establish endpoints of the circuit with optimal participants at nearby locations or the same location as the new caller, rather than establishing the endpoints between the new caller and a target participant of the conference call as the default endpoints. Optimized circuits being established between new callers and existing conference call participants can be provisioned entirely within the PSTN of a single service provider or can span across multiple service provider networks.

### TECHNICAL FIELD

The present disclosure relates generally to the field of public switched telephone networks (PSTN) and cognitive computing, and more particularly to predicting and establishing optimal switched circuits between a plurality of participants on a conference call based on location and/or minimized cost, as new callers enter or leave the conference call.

### BACKGROUND

A public switched telephone network is a combination of telephone networks used worldwide, including telephone lines, fiber optic cables, switching centers, cellular networks, satellites and cable systems. Although PSTN was originally a network of fixed-line analog telephone systems, the PSTN now include a digital core network that includes mobile communications. The PSTN is made up of switches at centralized points on a network that function as nodes to enable communication between two points on the network. A call is placed after being routed through multiple switches. Voice signals can then travel over the connected phone lines. The individual subscriber lines are connected to a local exchange, which communicates with trunk exchanges as well as main and central exchanges. The lines within a local exchange typically have the same area code. A user who wants to call a number outside the local exchange has to add an area code. To make an international call, a user has to dial the country code.

Most automated telephone exchanges on the PSTN use digital switching rather than mechanical or analog switching. The trunks connecting the exchanges are also digital and may be called circuits or channels. However analog two-wire circuits may still be used to connect the last mile from the exchange to the telephone at the destination or target location (also called the local loop). To carry a typical phone call from a calling party to a called party, the analog audio signal is digitized at an 8 kHz sample rate with 8-bit resolution using a special type of nonlinear pulse-code modulation known as G.711. The call is then transmitted from one end to another via telephone exchanges. The call is switched using a call set up protocol (usually ISUP) between the telephone exchanges under an overall routing strategy. The call is carried over the PSTN using a 64 kbit/s channel. The name given to this channel is Digital Signal 0 (DSO). The DS0 circuit is the basic granularity of circuit switching in a telephone exchange. A DS0 is also known as a timeslot because DS0s are aggregated in time-division multiplexing (TDM) equipment to form higher capacity communication links. In modern networks, the multiplexing function is moved as close to the end user as possible. These aggregated circuits are conveyed from the initial multiplexer to the exchange over a set of equipment collectively known as the access network.

### SUMMARY

Embodiments of the present disclosure relate to a computer-implemented method, an associated computer system and computer program products for dynamically establishing a circuit between participants of a conference call. The computer-implemented method comprises the steps of receiving, by a processor, a call from a new caller attempting to establish the call with a target participant engaged as one of the participants of the conference call; collecting, by the processor, location attributes and plan details or cost details from the participants of the conference call and the new caller; predicting, by the processor, an optimal participant from the participants of the conference call based on the location attributes and the plan details or cost details, to establish the circuit with the new caller; placing, by the processor, a ringing tone with the target participant of the conference call; upon the target participant selecting to merge the new caller into the conference call as a merged conference call, finalizing, by the processor, end points of the circuit comprising the participants and the new caller based on the location attributes, the plan details or the cost details of the participants, wherein the end points of the circuit are assigned to the new caller and the optimal participant of merged conference call if the new caller and the optimal participant are in a same location or nearby locations, otherwise, the endpoints of the circuit are assigned to the new caller and the target participant; and provisioning, by the processor, the circuit from one endpoint to another endpoint through a core network of a public switched telephone network (PSTN).

### BRIEF DESCRIPTION OF THE DRAWINGS

The drawings included in the present disclosure are incorporated into, and form part of, the specification. The drawings illustrate embodiments of the present disclosure and, along with the description, explain the principles of the disclosure. The drawings are only illustrative of certain embodiments and do not limit the disclosure.

FIG. 1 depicts a block diagram illustrating internal and external components of an embodiment of a computing system in which embodiments described herein may be implemented in accordance with the present disclosure.

FIG. 2 depicts a functional block diagram describing an embodiment of a computing environment for dynamically establishing a circuit between participants of a conference call, in accordance with the present disclosure.

FIG. 3A depicts a functional block diagram illustrating an example embodiment establishing a circuit in a first configuration connecting an ongoing conference call to an incoming call device merging with the conference call, wherein all participants reside on the network of the same service provider.

FIG. 3B depicts a functional block diagram illustrating an example of an alternative embodiment establishing a circuit in a second configuration connecting an ongoing conference call to an incoming call device merging with the conference call, wherein all participants reside on the network of the same service provider.

FIG. 4A depicts a functional block diagram illustrating an example of embodiment of a computing environment for merging a new caller into an ongoing conference call established between participants of separate service providers.

FIG. 4B depicts the computing environment of FIG. 4A, dynamically establishing a new circuit between a new call device on a service provider network merging with the conference call between participants of the separate service providers.

FIG. 5A depicts a flow diagram describing an embodiment of a method for dynamically establishing a circuit between participants of a conference call, in accordance with the present disclosure.

FIG. 5B depicts a flow diagram describing a continuation of the method of FIG. 5A for dynamically establishing a circuit between participants of a conference call, in accordance with the present disclosure.

FIG. 6A depicts a flow diagram describing a continuation of the method of FIG. 5A for dynamically establishing a circuit between participants of a conference call in accordance with the present disclosure.

FIG. 6B depicts a flow diagram describing a continuation of the method of FIG. 6A for dynamically establishing a circuit between participants of a conference call in accordance with the present disclosure.

### DETAILED DESCRIPTION

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The corresponding structures, materials, acts, and equivalents of all means or steps plus function elements in the claims below are intended to include any structure, material, or act for performing the function in combination with other claimed elements as specifically claimed. The description of the present disclosure has been presented for purposes of illustration and description but is not intended to be exhaustive or limited to the disclosure in the form disclosed. Many modifications and variations will be apparent to those of ordinary skill in the art without departing from the scope and spirit of the disclosure. The embodiments chosen and described are in order to best explain the principles of the disclosure, the practical applications and to enable others of ordinary skill in the art to understand the disclosure for various embodiments with various modifications as are suited to the particular use contemplated.

### Overview

Telecom service providers offer audio conference call features to end users, enabling features that allow three or more people to communicate together as part of an audio conference. Unlike audio technology often found in the corporate environment, which utilizes audio bridge circuits to join callers together in a conference call, personalized conference calling, initiated by individual mobile terminals and communication devices, such as telephones and mobile devices, are currently achieved by manually calling each participant and adding each participant to the conference call. In a situation where two or more participants of the conference call are located in different geographic regions and attempt to join the conference call by dialing each other, a circuit will be established between the two participants, without consideration for the participants' locations. Due to the geographic distance of the at least two participants calling one another, every participant of the call will then be accounted and billed for long distance charges, if at least one caller is outside of the same geographic region. Even in situations where other participants of the conference call are co-located within the same location or nearby locations that would otherwise not incur long distance charges.

The embodiments of the present disclosure recognize that there are currently no existing methods to dynamically establish circuits in a PTSN between co-located or nearby participants of a conference call when those co-located or nearby participants did not directly call one another. The currently static mechanism for establishing circuits between conference callers based on who the participants directly call rather than location or other factors of the remaining participants, leads to unnecessary long-distance charges, and unnecessary network resource waste due to core network elements being redundantly allocated to handle the transfer of audio packets to participants of the conference call. The magnitude of the network resource waste only compounds exponentially as the number of circuit-switched conference call participants increases.

Embodiments of the present disclosure may leverage the use of cognitive computing and machine learning to dynamically establish circuits of the conference call merging in new callers based on location attributes of the new caller and conference call participants, as well as the calling plans and/or costs associated with establishing the circuits with the different conference call participants. Embodiments of the present disclosure prioritize the establishment of circuits between call participants that co-located within the same location or nearby one another, and/or the most cost-effective participants to connect with the new caller. In some instances, the optimal participants being established as an endpoint of a circuit with the new caller(s) may not even be the target participant the new caller places a call with.

For example, if the new caller is trying to merge into a conference call by calling a first participant in another town or city, but a more optimal participant already connected to the ongoing conference call is in the same town or city as the new caller, then embodiments of the present disclosure can dynamically establish the endpoints of the circuit for the conference call between the new caller and the optimal participant co-located within the same town or city. As a result of the optimized circuit being established with the optimal participant, instead of the target participant, the conference call eliminates the need for redundant network channels spanning long distances. The long-distance circuit between the target participant and optimal participant and a short distance circuit between the optimal participant and new caller can be used, instead of two long distance circuits (i.e., from the target participant to both the optimal participant and the new caller). The circuit between the optimal participant and the new caller can be established seamlessly upon a call being placed to the target participant and the target participant merging the new caller into conference call, without the need for the new caller to call the optimal participant directly.

Furthermore, the cost effective, optimized circuits being established between new callers and existing conference call participants can span across multiple service provider networks. For example, a circuit can be established between new callers obtaining service from a first service provider and an optimal conference call participant receiving service from a second service provider. Embodiments of the first service provider may collect and analyze the location attributes, plan information and cost details associated with each participant of the conference call receiving service from the second service provider. Using the participant information collected from the second service provider, an optimal participant to establish a circuit with the new caller can be identified and upon merging the new caller into the conference call, the new circuit between the new caller and the optimal participant can be established, despite the use of different service providers.

### Computing System

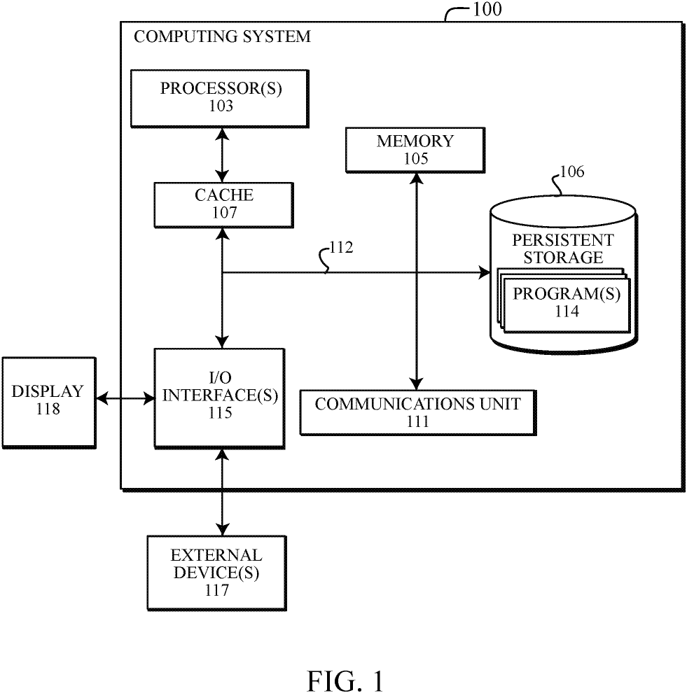

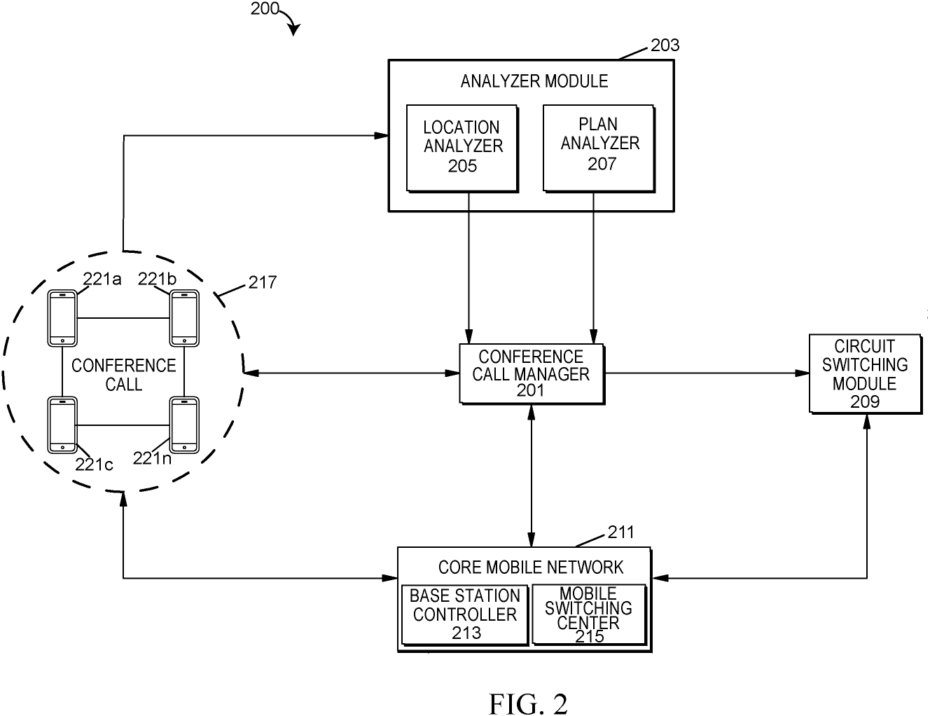

FIG. 1 illustrates a block diagram of an embodiment of a computing system 100, which may be a simplified example of a computing device (i.e., a physical bare metal system or virtual system) capable of performing the computing operations described herein directed toward dynamically establishing a circuit between participants of an ongoing conference call and new callers merging into the ongoing conference call. Computing system 100 may be representative of the one or more computing systems, devices or nodes implemented as part of a PSTN as shown in FIG. 2, in accordance with the embodiments of the present disclosure and further described below in detail. It should be appreciated that FIG. 1 provides only an illustration of one implementation of a computing system 100 and does not imply any limitations regarding the environments in which different embodiments may be implemented. In general, the components illustrated in FIG. 1 may be representative of any electronic device, either physical or virtualized, capable of executing machine-readable program instructions.

Although FIG. 1 shows one example of a computing system 100, a computing system 100 may take many different forms, including bare metal computer systems, virtualized computer systems, container-oriented architecture, and microservice-oriented architecture. For example, computing system 100 can take the form of real or virtualized systems, including but not limited to desktop computer systems, laptops, notebooks, tablets, servers, client devices, network devices, network terminals, thin clients, thick clients, kiosks, mobile communication devices (e.g., smartphones), multiprocessor systems, microprocessor-based systems, minicomputer systems, mainframe computer systems, smart devices, and/or Internet of Things (IoT) devices. The computing systems 100 can operate in a local computing environment, networked computing environment, a containerized computing environment comprising one or more distributed pods or containers, and/or a distributed cloud computing environment, which can include any of the systems or devices described herein and/or additional computing devices or systems known or used by a person of ordinary skill in the art.

Computing system 100 may include communications fabric 112, which can provide for electronic communications among one or more processor(s) 103, memory 105, persistent storage 106, cache 107, communications unit 111, and one or more input/output (I/O) interface(s) 115. Communications fabric 112 can be implemented with any architecture designed for passing data and/or controlling information between processor(s) 103 (such as microprocessors, CPUs, and network processors, etc.), memory 105, external devices 117, and any other hardware components within a computing system 100. For example, communications fabric 112 can be implemented as one or more buses, such as an address bus or data bus.

Memory 105 and persistent storage 106 may be computer-readable storage media. Embodiments of memory 105 may include random access memory (RAM) and/or cache 107 memory. In general, memory 105 can include any suitable volatile or non-volatile computer-readable storage media and may comprise firmware or other software programmed into the memory 105. Program(s) 114, software applications, processes, services, and installed components thereof, described herein, may be stored in memory 105 and/or persistent storage 106 for execution and/or access by one or more of the respective processor(s) 103 of the computing system 100.

Persistent storage 106 may include a plurality of magnetic hard disk drives, solid-state hard drives, semiconductor storage devices, read-only memories (ROM), erasable programmable read-only memories (EPROM), flash memories, or any other computer-readable storage media that is capable of storing program instructions or digital information. Embodiments of the media used by persistent storage 106 can also be removable. For example, a removable hard drive can be used for persistent storage 106. Other examples include optical and magnetic disks, thumb drives, and smart cards that are inserted into a drive for transfer onto another computer-readable storage medium that is also part of persistent storage 106.

Communications unit 111 provides for the facilitation of electronic communications between computing systems 100. For example, between one or more computer systems or devices via a communication network 250. In the exemplary embodiment, communications unit 111 may include network adapters or interfaces such as a TCP/IP adapter cards, wireless interface cards, or other wired or wireless communication links. Communication networks can comprise, for example, copper wires, optical fibers, wireless transmission, routers, load balancers, firewalls, switches, gateway computers, edge servers, and/or other network hardware which may be part of, or connect to, nodes of the communication networks including devices, host systems, terminals or other network computer systems. Software and data used to practice embodiments of the present disclosure can be downloaded to the computing systems 100 operating in a network environment through communications unit 111 (e.g., via the Internet, a local area network, or other wide area networks). From communications unit 111, the software and the data of program(s) 114 can be loaded into persistent storage 116.

One or more I/O interfaces 115 may allow for input and output of data with other devices that may be connected to computing system 100. For example, I/O interface 115 can provide a connection to one or more external devices 117 such as one or more smart devices, IoT devices, recording systems such as camera systems or sensor device(s), input devices such as a keyboard, computer mouse, touch screen, virtual keyboard, touchpad, pointing device, or other human interface devices. External devices 117 can also include portable computer-readable storage media such as, for example, thumb drives, portable optical or magnetic disks, and memory cards. I/O interface 115 may connect to human-readable display 118. Human-readable display 118 provides a mechanism to display data to a user and can be, for example, computer monitors or screens. For example, by displaying data as part of a graphical user interface (GUI). Human-readable display 118 can also be an incorporated display and may function as a touch screen, such as a built-in display of a tablet computer.

The present invention may be a system, a method, and/or a computer program product at any possible technical detail level of integration. The computer program product may include a computer-readable storage medium (or media) having the computer-readable program instructions thereon for causing a processor to carry out aspects of the present invention.

The computer-readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network, and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer-readable program instructions for storage in a computer-readable storage medium within the respective computing/processing device.

Computer-readable program instructions for carrying out operations of the present invention may be assembler instructions, instruction-set-architecture (ISA) instructions, machine instructions, machine-dependent instructions, microcode, firmware instructions, state-setting data, configuration data for integrated circuitry, or either source code or object code written in any combination of one or more programming languages, including an object-oriented programming language such as Smalltalk, C++, or the like, and procedural programming languages, such as the “C” programming language or similar programming languages. The computer-readable program instructions may execute entirely on the user’s computer, partly on the user’s computer, as a stand-alone software package, partly on the user’s computer and partly on a remote computer or entirely on the remote computer or server. In the latter scenario, the remote computer may be connected to the user’s computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer-readable program instructions by utilizing state information of the computer-readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer-readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer-readable program instructions may also be loaded onto a computer, other programmable data processing apparatus, or other devices to cause a series of operational steps to be performed on the computer, other programmable apparatus, or other devices to produce a computer-implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

### System for Dynamically Establishing Circuits Between Participants of a Conference Call

It will be readily understood that the instant components, as generally described and illustrated in the Figures herein, may be arranged and designed in a wide variety of different configurations. Accordingly, the following detailed description of the embodiments of at least one of a method, apparatus, non-transitory computer readable medium and system, as represented in the attached Figures, is not intended to limit the scope of the application as claimed but is merely representative of selected embodiments.

The instant features, structures, or characteristics as described throughout this specification may be combined or removed in any suitable manner in one or more embodiments. For example, the usage of the phrases “example embodiments,” “some embodiments,” or other similar language, throughout this specification refers to the fact that a particular feature, structure, or characteristic described in connection with the embodiment may be included in at least one embodiment. Accordingly, appearances of the phrases “example embodiments,” “in some embodiments,” “in other embodiments,” or other similar language, throughout this specification do not necessarily all refer to the same group of embodiments, and the described features, structures, or characteristics may be combined or removed in any suitable manner in one or more embodiments. Further, in the Figures, any connection between elements can permit one-way and/or two-way communication even if the depicted connection is a one-way or two-way arrow. Also, any device depicted in the drawings can be a different device. For example, if a mobile device is shown sending information, a wired device could also be used to send the information.

Detailed herein are embodiments of methods, systems and computer program products describing one or more approaches for dynamically establishing circuits between call devices 221a-221n connecting to conference calls 217 via a switched circuit network. Embodiments of the methods, systems and computer program products may be executed using one or more computing systems 100 operating within computing environments which may comprise underlying hardware or infrastructure capable of provisioning the circuits and one or more computing systems 100 operating as nodes of a network establishing and configuring the circuits. For example, as shown in the exemplary embodiment of FIG. 2, the computing environment 200 may be a PTSN or other type of switched circuit network, comprising underling infrastructure such as the core mobile network 211, and one or more nodes hosting components such as the conference call manager 201, analyzer module 203, and/or the circuit switching module 209. The term “module” may refer to a hardware module, software module, or a module may be a combination of hardware and software resources. Embodiments of hardware-based modules may include self-contained components such as chipsets, specialized circuitry, one or more memory 105 devices and/or persistent storage 106. A software-based module may be part of a program 114, program code or linked to program code containing specifically programmed instructions loaded into a memory 105 device or persistent storage 106 device of one or more nodes operating as part of the computing environment 200.

In the exemplary embodiment of FIG. 2, the computing environment 200 describes an approach for dynamically provisioning circuits amongst participants of a conference call 217 as new callers merge or drop out from the conference call via a call device 221a-221n (hereinafter referred to generally as call device 221"). Embodiments of the computing environment 200 may include one or more distributed computing systems 100, hardware and underlying infrastructure of the PSTN (i.e., core mobile network 211) both physical and/or virtualized, which may represent nodes hosted by a service provider’s communication network and may be interconnected via one or more computing networks. The interconnected nodes of the computing systems 100 communicating over the service provider’s network may host one or more hardware and/or software components for dynamically establishing circuits of the conference call 217. Nodes of the network hosting the components of the computing environment 200 may not only comprise the components depicted in FIG. 2 but may also incorporate one or more components of computing system 100, as shown in FIG. 1 and described in the COMPUTING SYSTEM section above. For example, nodes hosting one or more components of the computing environment may be integrated or provisioned one or more processor(s) 103, memory 105, persistent storage 106, cache 107, communications unit 111, I/O interface(s) 115, external device(s) 117 and/or display 118.

Embodiments of the components of computing environment 200, such as conference call manager 201, analyzer module 203, circuit switching module 209 may be hosted by any computing device (real or virtual) known in the art. For example, nodes hosting the components of computing environment 200 may include one or more desktop computers, laptops, tablets, mobile communication devices, server computers, mainframes, etc. Embodiments of the nodes hosting the conference call manager 201, analyzer module 203, circuit switching module 209 may be a single node hosting all of the components, separate and distinct nodes for hosting each component separately, or any combination of nodes that may host one or more components. In some embodiments, the nodes hosting one or more component of the computing environment 200 may include one or more computing devices representing clustered computers and components acting as a single pool of seamless resources when accessed through a network. For example, such embodiments may be part of storage area network (SAN), and network attached storage (NAS) applications.

Embodiments of service provider networks interconnecting the nodes of the computing environment 200 hosting the conference call manager 201, analyzer module 203, and circuit switching module 209 may be constructed using wired, wireless or fiber optic connections. The nodes hosting the components may connect and communicate over the network using a communication unit 111, such as a network interface controller or other network communication hardware. Embodiments of the communication unit 111 may implement specialized electronic circuitry allowing for communication using a specific physical layer and a data link layer standard. For example, Ethernet, Fiber channel, Wi-Fi or Token Ring. Communication unit 111 may further allow for a full network protocol stack, enabling communication over the network to a group of computer systems or other computing hardware devices linked together through communication channels. The network may facilitate communication and resource sharing among the nodes of computing environment 200. Examples of networks facilitating communication between nodes hosting one or more components of the computing environment 200 may include a local area network (LAN), home area network (HAN), wide area network (WAN), back bone networks (BBN), peer to peer networks (P2P), campus networks, enterprise networks, the Internet, cloud computing networks and any other network known by a person skilled in the art.

Referring to the specific components hosted by the nodes of computing environment 200, embodiments of analyzer module 203, may perform the functions, tasks and/or processes associated with collecting and analyzing location attributes of each caller participating or merging into a conference call 217, as well as the call plans and cost details associated with each caller participating or seeking to participate in a conference call 217. Embodiments of the analyzer module 203 may be further subdivided into two separate components for separately performing the location analysis and the analysis of each caller’s plan details. For example, as shown in FIG. 2, the analyzer module 203 may include subcomponents of a location analyzer 205 and a plan analyzer 207. As new callers seek to merge with existing conference calls 217, the location analyzer 205 may collect location attributes from each call device 221, when the callers of the conference call are part of the same service provider hosting the analyzer module 203. Embodiments of the location analyzer 205 may analyze the collected location attributes from each call device 221 participating in the conference call 217 and identify participants located near one another and/or participants located near the new caller seeking to merge into the ongoing conference call 217.

In some embodiments, call devices 221 being operated by participants of the conference call 217 and/or the new caller may be connected or operating on a plurality of different service provider networks. In such an instance where a new caller or any one of the participants of an ongoing conference call 217 are part of different service provider networks, location analyzer module 205 within the service provider network of the new caller may contact the other service provider network(s) to collect details describing the active participants of the conference call 217, the circuits established between participants of the conference call 217 and location attributes of each participant. Upon receiving a response to the request transmitted by the location analyzer module 205 of the new caller’s service provider network from the other service provider network, the location analyzer module 205 may analyze the call participants, the location attributes associated with each participants' call device 221 and perform location analysis identifying nearest participants of the other service provider network to the new caller attempting to merge into the conference call 217.

In some embodiments of the analyzer module 203, the analyzer module 203 may include a plan analyzer 207. The plan analyzer 207 may perform functions, tasks and/or processes of the analyzer module 203 associated with collecting calling plan information and associated cost details of the ongoing conference call 217 as well as the effects on the calling costs of the conference call 217 when a new caller may be merged into the conference call 217. The plan analyzer 207 can compare the plans and cost details associated with establishing the possible circuits between the new caller and one or more participants of the ongoing conference call 217. Moreover, in conjunction with the location attributes collected by the location analyzer 205, the combination of the plan analyzer 207 and location analyzer 205 can identify the best possible destination for establishing a new circuit. For example, establishing a circuit between call participants that minimizes calling costs, resource usage of the underlying infrastructure, such as the core mobile network 211 and/or a combination that balances cost and resource usage amongst the available options for establishing the new circuit between the new caller and the participants of the ongoing conference call 217.

Embodiments of the analyzer module 203, including the sub-components of the location analyzer 205 and/or plan analyzer 207 may be part of a cognitive computing system that is able to learn and classify different features and attributes of the new caller or callers participating on an ongoing conference call 217 and the associated call devices 221 in order to arrive at the most optimal participants to establish a circuit. Features and attributes that may be considered by the cognitive computing system running the analyzer module 203 (and subcomponents thereof) may include (but is not limited to) location of different participants, battery health of call devices 221, billing plans, and whether or not participants are considered to be long distance or local calls for establishing the circuit.

Learning and classification of the different features and attributes of the new caller or callers participating in the ongoing conference call 217 may be performed by using machine learning techniques to train a model capable of identifying and predicting the best combination of features and/or attributes for creating an optimal circuit for a conference call 217 that optimizes overall cost and resources for establishing the circuit. In the exemplary embodiment, analyzer module 203 and the sub-components thereof may use supervised learning techniques, which may create the model using manually labelled training data built from historical data describing previous conference calls and one or more corresponding features or attributes of the participants used for optimally merging new callers into an ongoing conference call 217.

Supervised learning may refer to a type of machine learning that may use one or more computer algorithms to train a predictive model using labeled examples during a training phase. The term “labeled example” may refer to the fact that during the training phase, there are desired inputs that will produce a known desired output by the model. The algorithm(s) may be trained by receiving a set of inputs along with the corresponding correct outputs. To employ supervised learning, the model may store a labeled dataset for learning, a dataset for testing and a final dataset from which the model may use for the one or more recommendations, actions, conclusions, or suggestions regarding the participants of the conference call 217 for dynamically establishing a new circuit with a new caller seeking to merge with the conference call. For instance, suggesting establishment of a new circuit between the new caller and a participant that is located within the same town or a nearby town as the new caller because such a connection would minimize costs incurred by the circuit as it would not be considered a long-distance call.

Embodiments of the supervised machine learning algorithms may learn by comparing the actual output with the correct outputs in order to find errors. The model may be modified in accordance with the correct outputs to refine the decision making of the model and improve the accuracy of the automated decisions to provide the correct inputs to the conference call manager 201. During the training phase, the model being developed may learn the correct outputs by analyzing and describing well known historical dataset of previously collected attributes or features about participants of a past conference call, including location attributes, calling plan details, costs, etc. Examples of data modeling include classification, regression, prediction and gradient boosting.

Embodiments of analyzer module 203 may output decisions and/or recommendations to the conference call manager 201 indicating the possible participants of the conference call 217 that may be optimal for establishing a new circuit with the new caller attempting to merge into the conference call 217. Embodiments of the conference call manager 201 may configure and finalize the end points of the new circuit being established for implementation by the PSTN or the switched circuit network, based on the decisions and recommendations received from the analyzer module 203 as input into the conference call manager 201. As a new caller attempts to place a call with a target participant of the conference call 217 in order to merge into the conference call 217, embodiments of the Conference call manager 201 may allow the ringing tones to be placed with the target participant. Using the call device 221 of the target participant, the target participant can elect to reject the incoming call or merge the call with the conference call, allowing the new caller, the target participant and the rest of the participants of the ongoing conference call 217 to converse together. Upon electing to merge the new caller into the conference call, embodiments of the conference call manager 201 may decide upon the endpoints of the circuit between the new caller and target participant or another optimal participant, as a function of the input received from analyzer module 203; as opposed to blindly establishing the circuit between the new caller and the target participant every single time.

In some embodiments, the conference call manager 201 can assign endpoints to the new circuit based on the location attributes, cost factors or other features of the participants in the ongoing conference call, to the new caller and an optimal call participant, which may or may not be the target participant of the conference call 217 that the new caller establishes a call with to merge with the conference call 217. For example, where the optimal participant of the conference call 217 is caller or party to the conference call 217 that is located in the same location or a nearby location to the new caller. Instead of establishing the endpoints of the new circuit between the target participant and the new caller, the conference call manager 201 can establish the endpoints of the new circuit as the new caller and the optimal participant having the same or nearby location as the new caller. Moreover, in situations where the new caller is currently in a location that is distant from all other participants of the conference call, or an optimal participant cannot be identified that would optimize cost or resource usage, the conference call manager 201 can configure the endpoints of the new circuit to be established as between the new caller and the target participant of the ongoing conference call 217.

Once endpoints are configured for assignment by the conference call manager 201, embodiments of the conference call manager 201 can instruct the circuit switching module 209 to provision the finalized endpoints of the circuit as configured by the conference call manager 201. In response to receiving instructions comprising the finalized endpoints configured by the conference call manager 201, embodiments of the circuit switching module 209 can provision the circuit(s) from one end to the other end, through the core network elements of the PSTN or switched circuit network constructing the circuit. In the exemplary embodiment of computing environment 200, the circuit provisioned by the circuit switching module 209 is constructed from the core network elements of the core mobile network 211 of the service provider network.

Embodiments of the service provider’s telecommunication network (e.g., a core mobile network 211) may include a base station controller 213 (BSC 213) and a mobile switching center 215 (MSC 215). Embodiments of the BSC 213 is a component of a telecommunication network, such as the core mobile network 211 responsible for controlling one or more base transceiver stations 403a-403c (hereinafter referred to generally as “BTS 403”). BSC 213 may control the activities of BTS 403 and MSC 215. Embodiments of the BSC 213 may be referred to as a mediator and physical link between the BTS 403 and the MSC 215. BSC 213 may also allocate radio channels, receive measurements from call devices 221, control BTS to BTS handover and call setup. Furthermore, embodiments of BSC 213 may store data which may include the frequency of the service provider, a frequency hopping list and power levels. The BSC 213 may manage BTS 403 activity to reduce workload on the MSC 215, which may allow the MSC 215 to focus on handling critical tasks such as traffic and database management functions. Furthermore, BSC 213 may also act as a translator which can convert 13kbps voice frequencies used by radio links to 64kbps frequencies that can be understood by a PTSN.

MSC 215 may be a core network element of a core mobile network 211. In particular, the MSC 215 may be a core part of GSM and CDMA mobile communication systems. MSC 215 may operate as a control center of Network Switching Subsystems (NSS) and may connect calls between subscribers of the core mobile network 211 by switching digital voice packets between network paths. Based on the size of the service provider’s network, a plurality of MSC 215 may be provided on the core mobile network 211. Embodiments of MSC 215 may be stationed between a BTS 403 and the PTSN. Mobile communications can be routed from the BTS 403 through MSC 215 wherein MSC 215 may be responsible for handling voice calls. Embodiments of MSC 215 initiates the call setup between subscribers in accordance with the endpoints prescribed by the conference call manager 201 and may also be responsible for real-time prepaid billing or account monitoring. MSC 215 may be responsible for inter-network communication between service providers. For example, MSC 215 may be responsible for inter BSC 213 handovers between base station controllers and inter MSC 215 handovers between mobile switching centers.

As call devices 221 of the conference call 217 attempt to drop or release from a conference call 217, embodiments of the conference call manager 201 may identify whether or not the call devices 221 dropping from the conference call are bridging in other conference call participants and may act accordingly to maintain the conference call 217 uninterrupted for the remaining participants. For example, if a call device 221 disconnecting from the ongoing conference call 217 is not bridging other conference call participants into the call, the circuit connecting the participant dropping off the conference call 217 can be released and the conference call can continue as otherwise established amongst the remaining participants. Alternatively, if the call device 221 attempting to remove itself from the conference call 217 is bridging one or more participants into the conference call 217, analyzer module 203 (and subcomponents thereof) can be executed to re-analyze the remaining participants for optimal participants to re-route the circuits. Allowing the conference call to continue with the remaining participants, keeping the conference call active while still optimized for location, cost, and/or other features.

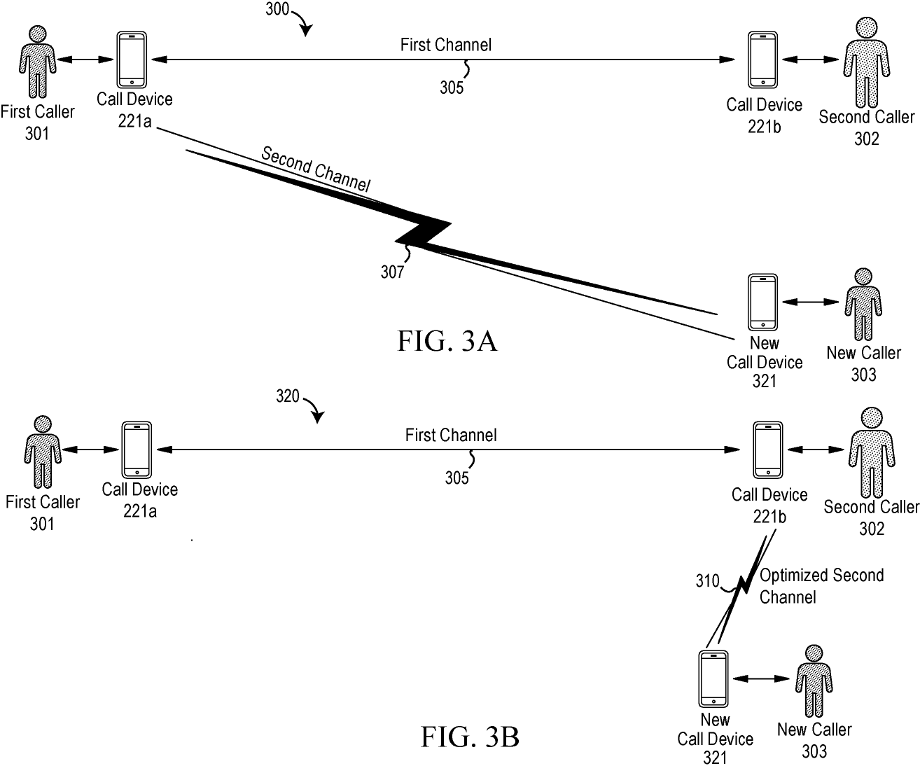

FIG. 3A to FIG. 3B depicts two examples of different scenarios 300, 320 for creating a new circuit between a call device 221 of a participant of an ongoing conference call 217 and a new call device 321 merging into the ongoing conference call based on the location attributes and/or features of the call devices 221a, 221b operated by a first caller 301 or second caller 302, and/or new call device 321 operated by new caller 303. In both of the examples depicted in FIG. 3A and FIG. 3B, all of the callers 301, 302, 303 are subscribers of the same service provider. Moreover, first caller 301 and second caller 302 are engaged in an ongoing conference call with a circuit established between call device 221a and call device 221b, providing a first channel 305 of communication for audio packets to travel between callers 301, 302 during the conference call. In both scenarios 300, 320 of the Figures, new caller 303 is attempting to merge into the ongoing call between first caller 301 and second caller 302. New caller 303 is attempting to merge into the ongoing call by placing a call from new call device 321 to call device 321a operated by the first caller 301 (i.e., the target participant).

In Scenario 300 of FIG. 3A, analyzer module 203 collects location attributes, calling plan details as well as any other useful features for predicting whether call device 221a or call device 221b would be optimal for establishing a circuit for the new call device 321 to merge into the ongoing call. In the scenario 300 of FIG. 3A, new call device 321 may be in a different location than call device 221b or based on the plan details of the participants to the call, placing a call with new caller’s 303 target participant (i.e., first caller) would result in the same or lower costs to establish the circuit than establishing the circuit with call device 221b, operated by the second caller. Conference call manager 201 may place a ringing tone with call device 221a, and upon the first caller 301 electing to merge new caller 303 into the conference call, the conference call manager 201 finalizes call device 221a and new call device 321 as endpoints of a new circuit. Circuit switching module 209 therefore provisions the core mobile network 211 for the new circuit according to the endpoints received from the conference call manager 201, wherein a circuit is established between call device 221a and new call device 321, comprising a second channel 307.

Scenario 320 of FIG. 3B differs from FIG. 3A, wherein location attributes and/or plans associated with second caller 302 and new caller 303 make establishing a circuit between call device 221b and new call device 321 more cost efficient and/or results in less resource usage than connecting a circuit between the new call device 321 and the call device 221a of the target participant, first caller 301. For example, second caller 302 and new caller 303 are in the same location or nearby locations which may establishing the circuit cheaper and requires less resources, that connecting new call device 321 over a long-distance circuit to call device 221a, resulting in a waste of network resources due to both call device 221b and new call device 321 being connected to call device 221a over a long-distance circuit. Instead, based on the location attributes, plan details and other features collected about first caller 301 and second caller 302, analyzer module 203 identifies that second caller 302 and new caller 303 are positioned within the same location or nearby locations. Accordingly, analyzer module 203 inputs the recommendation to conference call manager 201. Conference call manager 201 may place a ringing tone with call device 221a (the target participant for merging the call), and upon the first caller 301 electing to merge new caller 303 into the conference call, the conference call manager 201 finalizes call device 221b and new call device 321 as endpoints of a new circuit. Circuit switching module 209 therefore provisions the core mobile network 211 for the new circuit according to the endpoints received from the conference call manager 201, wherein a circuit is established between call device 221b and new call device 321, creating an optimized channel 310 over the short distance circuit between new call device 321 and call device 221b, while call device 221b maintains the previously provisioned long-distance circuit via first channel 305 with call device 221a.

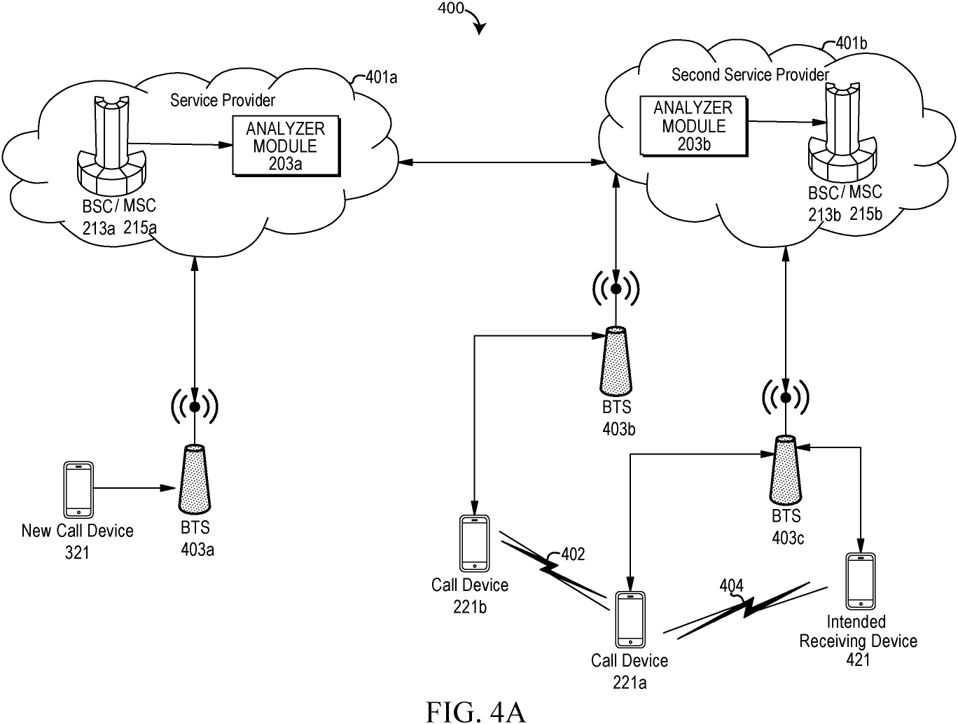

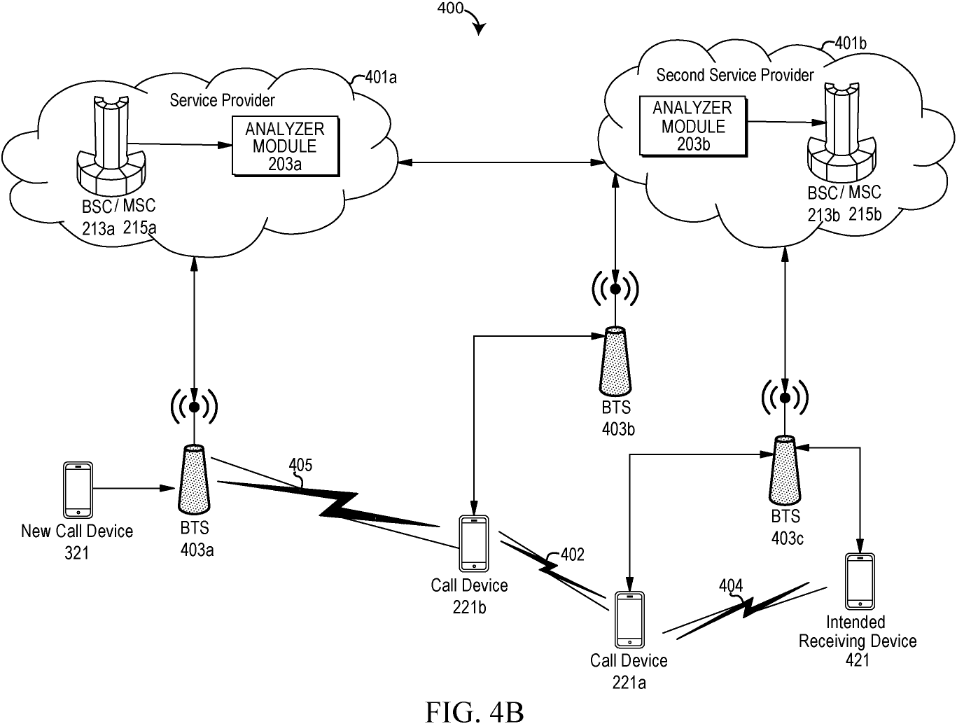

FIGS. 4A-4B depicts a scenario 400 dynamically establishing a circuit between a new call device 321 attempting to merge into an ongoing conference call. As shown in FIG. 4A, the conference call between call device 221a, call device 221b and intended receiving device 421 is being hosted by a second service provider 401b, and the new call device 321 attempting to merge into the ongoing conference call is hosted by the service provider 401a. As shown in FIG. 4A, the core network elements of second service provider 401b, including BSC 213b and MSC 215 have provisioned a plurality of circuits 402, 404 between the participants' call devices 221a, 221b, 421 connected to the various BTS 403b, 403c.

Since the devices of the end users are served by different service providers, the analyzer module 203a of the service provider 401a, hosting the new call device 321 seeking to merge into the existing conference call, may contact the analyzer module 203b of the second service provide 401b to collect location attributes, call plan information and other features of the participating devices currently connected to the active conference call the new call device 321 is seeking to merge into, as well as the established circuit 404 with the intended receiving device 421. In scenario 400 shown in FIGS. 4A-4B, analyzer module 203b may provide the location attributes, call details and other features about the call devices 221a, 221b, 421 participating in the active call. In this scenario 400, analyzer module 203a learns that intended receiving device 421 is participating in an active conference call with call devices 221a, 221b and that the location attributes and/or cost details of call device 221b indicate that call device 221b is located in the same location and/or near new call device 321. Resulting in a need to establish a short circuit between call device 221b and new call device 321 that may cost less than establishing the long-distance circuit between intended receiving device 421 and new call device 321.

Accordingly, based on the analysis of the location attributes, plan costs, call details and other features of the participants of the ongoing conference call, analyzer module 203a of the second service provider may recommend establishing endpoints of the new circuit at new call device 321 and call device 221b, instead of between new call device 321 and intended receiving device 421. Upon receiving input from the analyzer module 203a, the conference call manager 201 of the service provider 401a, may send a ringing tone to the intended receiving device 421 which may elect to merge new call device 321 into the ongoing conference call or reject the incoming call. Upon intended receiving device 421 electing to merge new call device 321 into the ongoing conference call, the conference call manager 201 may finalize new call device 321 and call device 221b as the endpoints of the new circuit. Conference call manager 201 instructs circuit switching module 209 of the service provider 401a to provision the new circuit with the endpoints finalized by the conference call manager 201, wherein the circuit switching module 209 provisions the new circuit via the BSC 213a and MSC 215a of the service provider’s 401a core mobile network 211. As a result, a new circuit 405 is established by the second service provider connecting new call device 321 to call device 221b, merging new call device 321 into the ongoing conference call comprising call device 221a, 221b and intended receiving device 421.

### Method for Dynamically Establishing Circuits Between Participants of a Conference Call

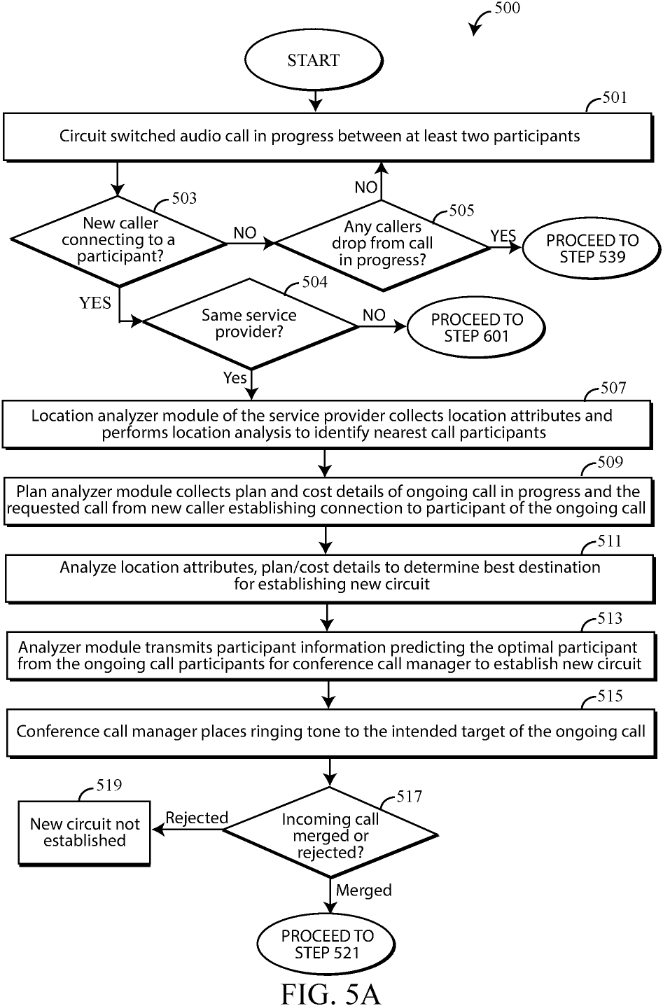

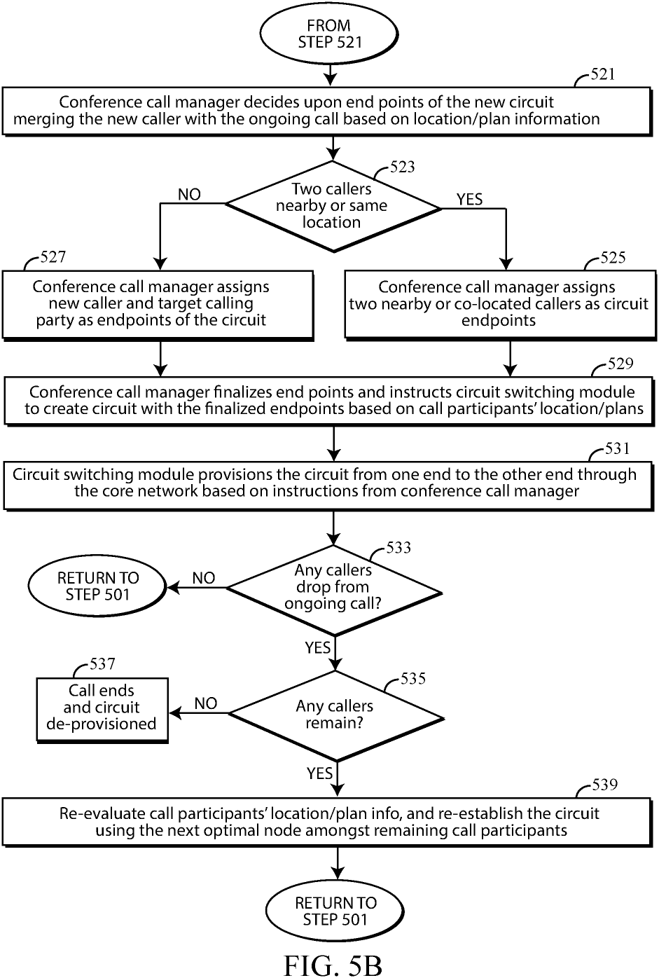

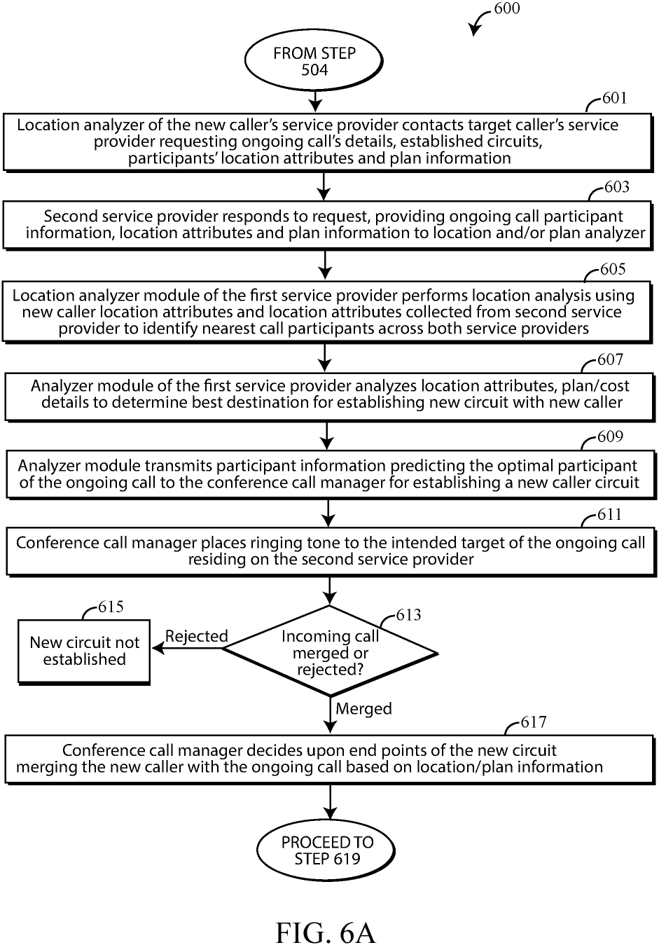

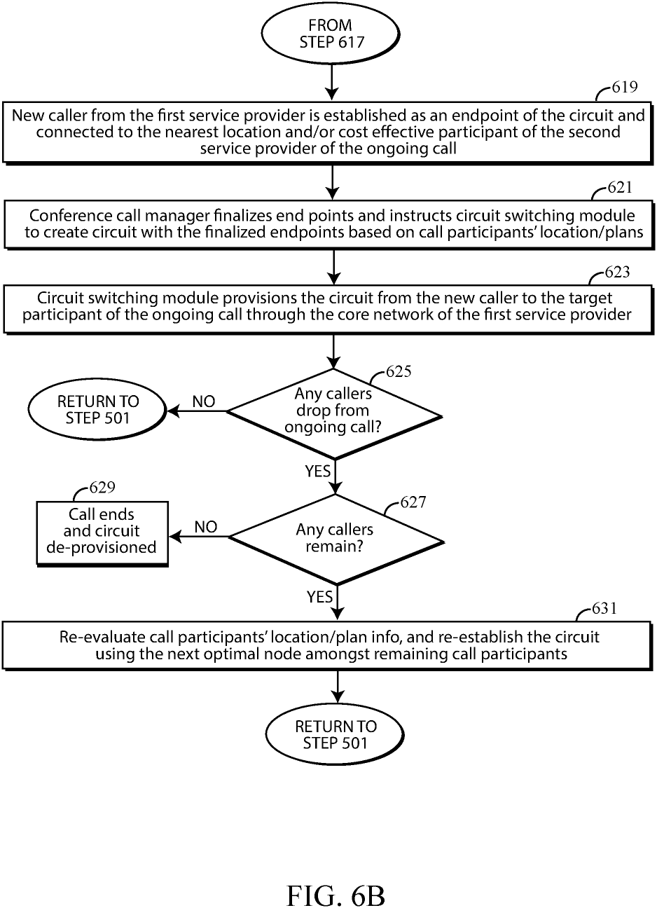

The drawings of FIGS. 5A-6B represent embodiments of algorithms for implementing a computerized method for dynamically establishing circuits between participants of a conference call as described in accordance with FIG. 2-4Babove, using one or more computing systems defined generically by computing system 100 of FIG. 1, and more specifically by the embodiments described herein. A person skilled in the art should recognize that the steps of the method described in FIGS. 5A-6B may be performed in a different order than presented and may not require all the steps described herein to be performed. Rather, some embodiments may alter the methods by using one or more of the steps discussed below.

FIG. 5A presents a flowchart illustrating an algorithm 500 for dynamically establishing circuits between participants of a conference call, in accordance with the embodiments of the present disclosure. The embodiment of the algorithm 500 may begin at step 501. At step 501, a conference call 217 provisioned on a circuit switched network is in progress between at least two participants, connected by at least one circuit constructed by the service provider’s network. At step 503 of algorithm 500, a determination is made whether a conference call manager 201 receives a request from a new calling device attempting to connect to a participant of the conference call. If a new participant is not attempting to connect to the ongoing conference call in step 503, the algorithm 500 may further proceed to step 505 to determine whether any callers of the ongoing conference call 217 have dropped from the conference call 217. If none of the current participants of the call have dropped, the algorithm loops back to step 501, as the conference call 217 continues. Likewise, where at least one caller does drop from the conference call, the algorithm may proceed to step 539 (discussed below) and the circuits may be re-provisioned in accordance with algorithms 500, 600 discussed herein.

Returning back to the determination made in step 503; if the algorithm 500 makes a determination that a new caller is attempting to connect to a participant of the ongoing conference call 217, the algorithm 500 may proceed to step 504, wherein a further determination may be made whether or not the new caller seeking to join the conference call 217 is part of the same service provider network as one or more of the participants currently connected on the conference call 217. If the new caller attempting to merge into the conference call is not part of the same service provider network as at least one of the conference call participants, the algorithm 500 may proceed to step 601 wherein algorithm 600 may be followed for dynamically establishing a circuit with the new caller and participant(s) of the conference call between multiple service provider networks. Conversely, where in step 504, there is a determination that the new caller seeking to merge into the conference call 217 is connected or subscribed to the same service provider as at least one conference call participant, the algorithm 500 may proceed to step 507.

During step 507 of algorithm 500, a location analyzer module 205 of an analyzer module 203 may collect location attributes and data from each of the call participants of the conference call 217, as well as the new caller attempting to merge into the conference call 217. Using the collected location attributes and/or data, the location analyzer 205 may use a cognitive computing model to perform a location analysis on the location attributes and data collected from each of the conference call participants. Based on the location analysis, the location analyzer 205 can identify and/or predict the locations of conference call participants nearest to the new caller attempting to merge into the conference call, and further determine whether any of the conference call participants' locations are within the same location or a nearby location.

During step 509, a plan analyzer module 207 of the analyzer module 203 analyzes plan information and/or cost details from the participants of the ongoing conference call 217 and the new caller attempting to merge into the conference call. Plan information and cost details may be analyzed in order to identify the participants that the new caller could connect with via a circuit that would have the lowest costs associated therewith. In step 511, analyzer module 203 may analyze both the cost and plan data collected by the plan analyzer in view of location attributes and may determine the optimal participants of the conference call for establishing the circuit with the new caller. In step 513, the analyzer module 203 may output predictions and recommendations for establishing the new circuit, including recommendations for the optimal participants based on costs, plan information, location, and/or other features discussed herein. The recommendations and/or predictions from the analyzer module 203 may be inputted into the conference call manager 201.

During step 515 of algorithm 500, the conference call manager 201 may place a ringing tone with an intended target device that the new caller is attempting to call in order to be merged into the conference call 217. In step 517, a determination is made whether or not the intended target device receiving the incoming ringing tone from the conference call manager 201 rejects the incoming call or merges the incoming call with the ongoing conference call 217. If the intended target device rejects the incoming call, the algorithm proceeds to step 519, wherein the new circuit is not established with the new caller and the algorithm 500 ends. Conversely, if the intended target device receiving the incoming ringing tone from the conference call manager 201 elects to merge the incoming call with the ongoing conference call 217, the algorithm 500 may proceed to step 521.

During step 521 of algorithm 500, the conference call manager 201 may decide upon the end points of the new circuit that will be configured for merging the new caller with the ongoing conference call, based on the analysis of location, calling plan details, associated costs, and/other features of the conference call participants. In an exemplary embodiment of algorithm 500 the algorithm in step 523 the algorithm 500 is shown using location as a determining factor for deciding upon the end points of the circuity. However, the conference call manager 201 may also use plan information, costs, a calling device’s battery health, or any other feature to decide which participants are optimal participants for establishing the new circuit. As shown in FIG. 5B, when location is a determining factor, in step 523 a determination can be made whether the new caller and any of the participants of the ongoing conference call 217 are in the same or nearby location. If the new caller and at least one conference call participant are in the same location, the algorithm may proceed to step 525, wherein the conference call manager assigns the two nearby or co-located callers (i.e., the new caller and the nearby conference call participant) as the endpoints of the new circuit. Alternatively, where the new caller is not in the same or nearby location as another call participant, the algorithm 500 may proceed to step 527 and the conference call manager 201 may assign the new caller and the target calling party receiving the ringing tone to merge in the new caller, as the endpoints of the circuit.

During step 529, the conference call manager 201 finalizes the end points of the new circuit and instructs the circuit switching module 209 to provision the circuit with the finalized endpoints based on the call participants' location, plan details, costs or other features as the deciding factors. In step 531, the circuit switching module 209 provisions the circuit from one endpoint to the other endpoint per the instructions of the conference call manager 201, through the core network of the service provider. For example, provisioned and controlled via the BSC 213 and MSC 215 of the core mobile network 211.

During step 533, the algorithm 500 may check and determine whether or not any of the callers participating in the merged conference call have attempted to drop from the merged conference call. If none of the participants have attempted to drop off of the merged conference call, the algorithm 500 may return back to step 501 as the conference call proceeds. Alternatively, where one or more participants of the ongoing call attempt to remove themselves from the merged conference call, a second determination may be made in step 535 as to whether or not upon the removal of the participants attempting to remove themselves from the merged conference call, will there be any remaining participants on the call? If upon participants leaving the merged conference call no remaining participants remain, the algorithm may proceed to step 537, whereby the merged conference call ends, and each of the established circuits are released and deprovisioned by the circuit switching module 209. Moreover, if during step 535 there is a determination that one or more callers remain participants of the merged conference call, then during step 539, the remaining participants' location, plan data, associated costs and other features may be re-evaluated and circuits may be re-stablished using the next optimal participants as the endpoints amongst the remaining call participants, as per steps 507-515 and 521-531 described above. Following re-establishment of the circuits between the remaining call participants, the algorithm 500 may return to step 501, wherein the remaining participants may continue with the conference call uninterrupted.

Referring to FIG. 6A, algorithm 600 provides a method for dynamically creating circuits of a conference call hosted by a switched circuit network when more than one service provider is determined in step 504 of algorithm 500. Proceeding from step 504 discussed above to step 601, during step 601, a location analyzer 205 of a new caller’s service provider may contact a target caller’s service provider. The location analyzer of the new caller’s service provider may request call details of the ongoing conference call hosted by the second service provider network, including details describing established circuits, location attributes of call participants, plan information of the participants, costs, and other features of the call participants. In step 603, the second service provider may respond to the request and provide the requested information about the call participants, location attributes, plan information, etc. to the location analyzer 205 and/or plan analyzer 207 of the new caller’s service provider.

During step 605 of algorithm 600, a location analyzer module 205 of the first service provider may perform location analysis on the collected location attributes and/or data received from the location analyzer 205 of the second service provider. Embodiments of the location analyzer 205 may use a cognitive computing model to perform a location analysis on the location attributes and data collected from each of the conference call participants and the new caller. Based on the location analysis, the location analyzer 205 can identify and/or predict the locations of conference call participants nearest to the new caller attempting to merge into the conference call, and further determine whether any of the conference call participants' locations are within the same location as the new caller or a nearby location.

During step 607, a plan analyzer module 207 of the analyzer module 203 for the first service provider analyzes plan information and/or cost details of the participants of the ongoing conference call 217 and the new caller attempting to merge into the conference call. Plan information and cost details may be analyzed in order to identify the participants that the new caller could connect with via a circuit that would have the lowest costs associated therewith. During step 609, analyzer module 203 of the first service provider may analyze both the cost and plan data collected from the plan analyzer 207 of the first service provider in view of location attributes and may determine the optimal participant of the second provider network participating in the conference call for establishing the circuit with the new caller. The analyzer module 203 of the first service provider may output predictions and recommendations for establishing the new circuit, including recommendations for the optimal participants based on costs, plan information, location, and/or other features discussed herein. The recommendations and/or predictions from the analyzer module 203 may be inputted into the conference call manager 201 of the first service provider.

During step 611 of algorithm 600, the conference call manager 201 of the first service provider may place a ringing tone with an intended target device of the second service provider network, that the new caller is attempting to call in order to be merged into the conference call 217. In step 613, a determination is made whether or not the intended target device receiving the incoming ringing tone from the conference call manager 201 of the first service provider rejects the incoming call or merges the incoming call with the ongoing conference call 217. If the intended target device rejects the incoming call, the algorithm proceeds to step 615, wherein the new circuit is not established with the new caller and the algorithm 600 ends. Conversely, if the intended target device receiving the incoming ringing tone from the conference call manager 201 elects to merge the incoming call with the ongoing conference call 217, the algorithm 600 may proceed to step 617.

During step 617 of algorithm 600, the conference call manager 201 of the first service provider may decide upon the end points of the new circuit that will be configured for merging the new caller of the first service provider with a participant of the ongoing conference call hosted by the second service provider, based on the analysis of location, calling plan details, associated costs, and/other features of the conference call participants. In step 619 the new caller from the first service provider is established as an endpoint of the circuit and will be connected to the optimal participant of the second service provider network nearest in location to the new caller and/or the most cost-effective participant of the second service provider network of the ongoing conference call.

During step 621, the conference call manager 201 finalizes the end points of the new circuit and instructs the circuit switching module 209 of the first service provider to provision the circuit with the finalized endpoints based on the call participants' location, plan details, costs or other features as the deciding factors. In step 623, the circuit switching module 209 of the first service provider provisions the circuit from one endpoint to the other endpoint per the instructions of the conference call manager 201, through the core network of the first service provider. For example, provisioned and controlled via the BSC 213 and MSC 215 of the first service provider’s core mobile network 211.

During step 625, the algorithm 600 may check and determine whether or not any of the callers participating in the merged conference call from either service provider network have attempted to drop from the merged conference call. If none of the participants have attempted to drop off of the merged conference call, the algorithm 600 may return back to step 501 of algorithm 500, as the conference call proceeds. Alternatively, where one or more participants of the ongoing call attempt to remove themselves from the merged conference call, a second determination may be made in step 627 as to whether or not upon the removal of the participants attempting to remove themselves from the merged conference call, will there be any remaining participants on the call? If upon participants leaving the merged conference call no remaining participants remain, the algorithm may proceed to step 629, whereby the merged conference call ends, and each of the established circuits from each of the service providers are deprovisioned by the respective circuit switching module 209 of the associated service provider. Moreover, if during step 627 there is a determination that one or more callers remain participants of the merged conference call, then during step 631, the remaining participants' location, plan data, associated costs and other features may be re-evaluated and circuits may be re-stablished using the next optimal participants as the endpoints amongst the remaining call participants, as per steps 507-515 and 521-531 described above if all remaining participants belong to the same service provider and/or steps 601-611 and 617-623 if one or more participants are associated with different service providers. Following re-establishment of the circuits in step 631 between the remaining call participants, the algorithm 600 may return to step 501 of algorithm 500, wherein the remaining participants may continue with the conference call uninterrupted.

What is claimed is:

1. A computer-implemented method for dynamically establishing a circuit between participants of a conference call comprising:
receiving, by a processor, a call from a new caller attempting to establish the call with a target participant engaged as one of the participants of the conference call;
collecting, by the processor, location attributes and plan details or cost details from the participants of the conference call and the new caller;
predicting, by the processor, an optimal participant from the participants of the conference call based on the location attributes and the plan details or the cost details, to establish the circuit with the new caller;
placing, by the processor, a ringing tone with the target participant of the conference call;
upon the target participant selecting to merge the new caller into the conference call as a merged conference call, finalizing, by the processor, endpoints of the circuit comprising the participants and the new caller based on the location attributes, the plan details or the cost details of the participants, wherein the endpoints of the circuit are assigned to the new caller and the optimal participant of merged conference call if the new caller and the optimal participant are in a same location or nearby locations, otherwise, the endpoints of the circuit are assigned to the new caller and the target participant; and
provisioning, by the processor, the circuit from one endpoint to another endpoint through a core network of a public switched telephone network (PSTN).

2. The computer-implemented method of claim 1, wherein the new caller and the optimal participant are within the same location or nearby locations and the optimal participant is any participant of the conference call other than the target participant.

3. The computer-implemented method of claim 1, further comprising:
releasing, by the processor, at least one participant from the merged conference call provisioned as an endpoint of the circuit upon the at least one participant leaving the merged conference call;
re-evaluating, by the processor, remaining participants of the merged conference call for a next optimal participant to establish a new circuit based on the location attributes and the plan details or the cost details; and
re-establishing, by the processor, a new circuit between the new caller and the next optimal participant of the merged conference call, keeping the merged conference call active.

4. The computer-implemented method of claim 1, wherein predicting the optimal participant identifies a participant from the participants of the conference call with a location attribute closest to location attributes of the new caller and least expensive long-distance charges for establishing the circuit with the new caller.

5. The computer-implemented method of claim 1, wherein the participants of the conference call are connected as circuits hosted by a first service provider network, and the new caller is hosted by a second service provider network.

6. The computer-implemented method of claim 5, wherein collecting location attributes and plan details or cost details from the participants of the conference call and the new caller further comprises:
transmitting, by the processor, a request from the second service provider network to the first service provider network requesting the location attributes, plan details or cost details of the participants of the conference call.

7. The computer-implemented method of claim 6, wherein provisioning the circuit from one end point to another end point provisions the circuit from the new caller on the second service provider network as a first endpoint to the optimal participant on the first service provider network as a second end point of the circuit.

8. A computer system for dynamically establishing a circuit between participants of a conference call, the computer system comprising:
a processor; and
a computer-readable storage media coupled to the processor, wherein the computer-readable storage media contains program instructions executing a computer-implemented method comprising:
receiving, by the processor, a call from a new caller attempting to establish the call with a target participant engaged as one of the participants of the conference call;
collecting, by the processor, location attributes and plan details or cost details from the participants of the conference call and the new caller;
predicting, by the processor, an optimal participant from the participants of the conference call based on the location attributes and the plan details or the cost details, to establish the circuit with the new caller;
placing, by the processor, a ringing tone with the target participant of the conference call;
upon the target participant selecting to merge the new caller into the conference call as a merged conference call, finalizing, by the processor, endpoints of the circuit comprising the participants and the new caller based on the location attributes, the plan details or the cost details of the participants, wherein the endpoints of the circuit are assigned to the new caller and the optimal participant of merged conference call if the new caller and the optimal participant are in a same location or nearby locations, otherwise, the endpoints of the circuit are assigned to the new caller and the target participant; and
provisioning, by the processor, the circuit from one end point to another end point through a core network of a public switched telephone network (PSTN).

9. The computer system of claim 8, wherein the new caller and the optimal participant are within the same location or nearby locations and the optimal participant is any participant of the conference call other than the target participant.

10. The computer system of claim 8, further comprising:
releasing, by the processor, at least one participant from the merged conference call provisioned as an endpoint of the circuit upon the at least one participant leaving the merged conference call;
re-evaluating, by the processor, remaining participants of the merged conference call for a next optimal participant to establish a new circuit based on the location attributes and the plan details or the cost details; and
re-establishing, by the processor, a new circuit between the new caller and the next optimal participant of the merged conference call, keeping the merged conference call active.

11. The computer system of claim 8, wherein predicting the optimal participant identifies a participant from the participants of the conference call with a location attribute closest to location attributes of the new caller and least expensive long-distance charges for establishing the circuit with the new caller.

12. The computer system of claim 8, wherein the participants of the conference call are connected as circuits hosted by a first service provider network, and the new caller is hosted by a second service provider network.

13. The computer system of claim 12, wherein collecting location attributes and plan details or cost details from the participants of the conference call and the new caller further comprises:
transmitting, by the processor, a request from the second service provider network to the first service provider network requesting the location attributes, the plan details or the cost details of the participants of the conference call.

14. The computer system of claim 13 wherein provisioning the circuit from one end point to another end point provisions the circuit from the new caller on the second service provider network as a first endpoint to the optimal participant on the first service provider network as a second end point of the circuit.

15. A computer program product for dynamically establishing a circuit between participants of a conference call comprising:
one or more computer readable storage media having computer-readable program instructions stored on the one or more computer readable storage media, said program instructions executes a computer-implemented method comprising:
receiving, by a processor, a call from a new caller attempting to establish the call with a target participant engaged as one of the participants of the conference call;
collecting, by the processor, location attributes and plan details or cost details from the participants of the conference call and the new caller;
predicting, by the processor, an optimal participant from the participants of the conference call based on the location attributes and the plan details or the cost details, to establish the circuit with the new caller;
placing, by the processor, a ringing tone with the target participant of the conference call;
upon the target participant selecting to merge the new caller into the conference call as a merged conference call, finalizing, by the processor, endpoints of the circuit comprising the participants and the new caller based on the location attributes, the plan details or the cost details of the participants, wherein the endpoints of the circuit are assigned to the new caller and the optimal participant of merged conference call if the new caller and the optimal participant are in a same location or nearby locations, otherwise, the endpoints of the circuit are assigned to the new caller and the target participant; and
provisioning, by the processor, the circuit from one end point to another end point through a core network of a public switched telephone network (PSTN).

16. The computer program product of claim 15, wherein the new caller and the optimal participant are within the same location or nearby locations and the optimal participant is any participant of the conference call other than the target participant.

17. The computer program product of claim 15, further comprising:
releasing, by the processor, at least one participant from the merged conference call provisioned as an endpoint of the circuit upon the at least one participant leaving the merged conference call;
re-evaluating, by the processor, remaining participants of the merged conference call for a next optimal participant to establish a new circuit based on the location attributes and the plan details or the cost details; and
re-establishing, by the processor, a new circuit between the new caller and the next optimal participant of the merged conference call, keeping the merged conference call active.

18. The computer program product of claim 15, wherein predicting the optimal participant identifies a participant from the participants of the conference call with a location attribute closest to location attributes of the new caller and least expensive long-distance charges for establishing the circuit with the new caller.

19. The computer program product of claim 15, wherein the participants of the conference call are connected as circuits hosted by a first service provider network, and the new caller is hosted by a second service provider network and collecting location attributes and plan details or cost details from the participants of the conference call and the new caller further comprises:
transmitting, by the processor, a request from the second service provider network to the first service provider network requesting the location attributes, plan details or cost details of the participants of the conference call.

20. The computer program product of claim 19, wherein provisioning the circuit from one end point to another end point provisions the circuit from the new caller on the second service provider network as a first endpoint to the optimal participant on the first service provider network as a second end point of the circuit.
